(19) United States
(12) Patent Application Publication
(10) Pub. No.: US 2023/0154294 A1
(43) Pub. Date: May 18, 2023

(54) DYNAMIC STIMULUS PRESENTATION SYSTEM AND METHOD

(71) Applicant: Nippon Telegraph and Telephone Corporation, Tokyo (JP)

(72) Inventors: Arinobu NIIJIMA, Musashino-shi, Tokyo (JP); Toki TAKEDA, Musashino-shi, Tokyo (JP); Takafumi MUKOUCHI, Musashino-shi, Tokyo (JP); Takashi SATO, Musashino-shi, Tokyo (JP)

(21) Appl. No.: 17/913,373

(22) PCT Filed: Apr. 27, 2020
(86) PCT No.: PCT/JP2020/017951

§ 371 Date: Sep. 21, 2022

(51) Int. Cl. G08B 6/00

(52) U.S. Cl. CPC G08B 6/00

(57) ABSTRACT

A motion sense stimulus presentation system for presenting a motion sense, which is a sense representing motion, by generating different types of stimuli includes a stimulus signal generation unit that generates a first stimulus signal and a second stimulus signal in accordance with a first stimulus parameter and a second stimulus parameter, a first stimulus conversion unit that converts the first stimulus signal into one type of stimulus, and a second stimulus conversion unit that changes the second stimulus signal to the other type of stimulus.

### CROSS-REFERENCE TO RELATED APPLICATIONS

This application is a National Stage application under 35 U.S.C. § 371 of International Application No. PCT/JP2020/017951, having an International Filing Date of Apr. 27, 2020.

The disclosure of the prior application is considered part of the disclosure of this application, and is incorporated by reference in its entirety into this application.

### TECHNICAL FIELD

The present disclosure relates to a motion sense stimulus presentation system and a method thereof.

### BACKGROUND ART

Tactile feedback using a vibration stimulus is widely used in mobile and wearable terminals such as smartphones, tablets, and smart watches. To improve a sense of existence and a sense of immersion in virtual reality (VR) and augmented reality (AR) applications, one method of the vibration stimulus is to present a motion of a virtual object by the vibration stimulus.

As disclosed, for example, in NPL 1, the motion of the virtual object can be expressed by changing a position to which the vibration stimulus is applied in accordance with a moving direction by using a plurality of vibration motors.

### CITATION LIST

### Non Patent Literature

NPL 1: Ali Israr and Ivan Poupyrev, “Tactile brush: Drawing on Skin with a Tactile Grid Display.” Proceedings of the SIGCHI Conference on Human Factors in Computing Systems, 2011.

### SUMMARY OF THE INVENTION

### Technical Problem

Unfortunately, the method disclosed in NPL 1 uses the plurality of vibration motors to represent the motion of the virtual object. This method is difficult to use due to many restrictions particularly when mobile devices and wearable devices are assumed.

The present disclosure has been made in response to this issue, and an object of the present disclosure is to provide a motion sense stimulus presentation system and a method thereof, which are suitably applied to mobile devices and wearable devices.

### Means for Solving the Problem

A motion sense stimulus presentation system according to one aspect of the present disclosure for presenting a motion sense, which is a sense representing a motion, by generating different types of stimuli includes a stimulus signal generation unit that generates a first stimulus signal and a second stimulus signal in accordance with a first stimulus parameter and a second stimulus parameter, a first stimulus conversion unit that converts the first stimulus signal into one of the different types of stimuli, and a second stimulus conversion unit that changes the second stimulus signal to the other of the different types of stimuli.

In addition, a motion sense stimulus presentation method according to one aspect of the present disclosure performed by a motion sense stimulus presentation system includes generating, by a stimulus signal generation unit, a first stimulus signal and a second stimulus signal in accordance with a first stimulus parameter and a second stimulus parameter, converting, by a first stimulus conversion unit, the first stimulus signal into the one type of stimulus, and converting, by a second stimulus conversion unit, the second stimulus signal to the other type of stimulus.

### Effects of the Invention

The present disclosure enables the motion sense, which is the sense representing the motion, to be presented without the plurality of vibration motors.

### BRIEF DESCRIPTION OF DRAWINGS

FIG. 1 is a block diagram illustrating a functional configuration example of a motion sense stimulus presentation system according to a first embodiment of the present disclosure.

FIG. 2 is a view schematically illustrating an example of a first stimulus signal in FIG. 1.

FIG. 3 is a view schematically illustrating another example of the first stimulus signal in FIG. 1 and an example of a second stimulus signal.

FIG. 4 is a view schematically illustrating a state in which different types of stimuli are generated and presented by the motion sense stimulus presentation system in FIG. 1.

FIG. 5 is a block diagram illustrating a functional configuration example of a motion sense stimulus presentation system according to a second embodiment of the present disclosure.

FIG. 6 is a view schematically illustrating a state in which different types of stimuli are generated and presented by the motion sense stimulus presentation system in FIG. 5.

FIG. 7 is a block diagram illustrating a functional configuration example of a motion sense stimulus presentation system according to a third embodiment of the present disclosure.

FIG. 8 is an operation flowchart illustrating a processing step of a motion sense stimulus presentation method according to the present disclosure.

### DESCRIPTION OF EMBODIMENTS

Hereinafter, embodiments of the present disclosure will be described with reference to the accompanying drawings. The same reference signs are given to the same constituent elements which are the same in the plurality of drawings, and description thereof is not repeated.

### First Embodiment

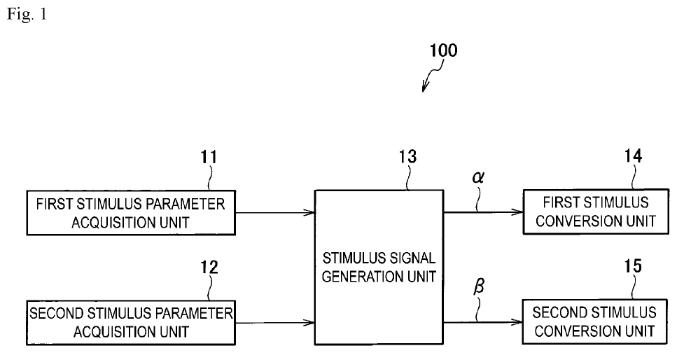

FIG. 1 is a block diagram illustrating a functional configuration example of a motion sense stimulus presentation system according to a first embodiment of the present disclosure. A motion sense stimulus presentation system 100 in FIG. 1 presents a motion sense, which is a sense representing a motion by generating different types of stimuli.

The motion sense stimulus presentation system 100 includes a first stimulus parameter acquisition unit 11, a second stimulus parameter acquisition unit 12, a stimulus signal generation unit 13, a first stimulus conversion unit 14, and a second stimulus conversion unit 15. For example, a type of first stimulus is the vibration stimulus by the vibration motor. For example, a type of second stimulus is a wind stimulus by air movement.

The first stimulus parameter acquisition unit 11 acquires each piece of information such as amplitude, a frequency, and a presentation time, which are parameters of the vibration stimulus. A vibration pattern and intensity of the vibration stimulus are set by these parameters.

The first stimulus parameter is input by a user from an operation panel (not illustrated) included in the motion sense stimulus presentation system 100. Alternatively, the first stimulus parameter may be treated as a predetermined value while previously recorded in the motion sense stimulus presentation system 100. When the first stimulus parameter is treated as the predetermined value, the first stimulus parameter acquisition unit 11 is unnecessary.

The second stimulus parameter acquisition unit 12 acquires each piece of information such as the intensity, an air orientation, and the presentation time, which are parameters of the wind stimulus. The pattern and intensity of the wind stimulus are set by these parameters. The method for setting the second stimulus parameter is the same as that of the first stimulus parameter.

The stimulus signal generation unit 13 generates a first stimulus signal α and a second stimulus signal β in accordance with the first stimulus parameter acquired by the first stimulus parameter acquisition unit 11 and the second stimulus parameter acquired by the second stimulus parameter acquisition unit 12. The first stimulus signal α and the second stimulus signal β are different electrical signals depending on the type of conversion unit that converts the respective stimulus signal into the stimulus. The conversion unit will be described below.

Human perception is dulling for the stimulus in which magnitude does not change. On the other hand, the human perception is sensitive to the stimulus in which the magnitude changes. Thus, the first stimulus signal α and the second stimulus signal β are preferably changed in response to a time lapse.

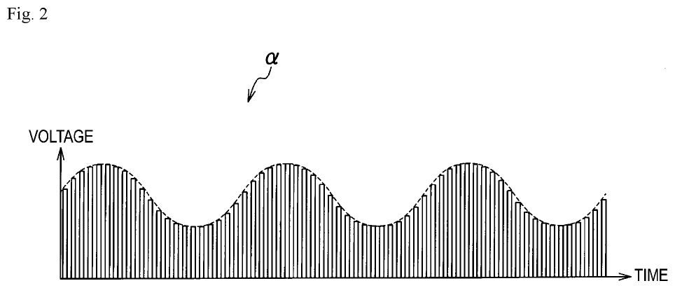

FIG. 2 is a view schematically illustrating an example of the first stimulus signal α. In FIG. 2, a horizontal axis indicates time, and a vertical axis indicates voltage.

As illustrated in FIG. 2, for example, the first stimulus signal α is a voltage signal that can be represented by the following equation.

[Math. 1]

Vα=V₀+A sin ωt (1)

For example, when Vα is applied to a DC motor, the DC motor rotates fast when a value of Vα is large. The DC motor rotates slowly when the value of Vα0 is small. Consequently, when the first stimulus signal α represented by the equation (1) is applied to the DC motor, the vibration stimulus can be generated.

The example in FIG. 2 is a sine wave, but the embodiment is not limited to the example. The magnitude of the first stimulus signal α and the second stimulus signal β may be varied in a saw wave, a square wave, or the like. Furthermore, the signal may be a signal having a fixed size representing on and off without changing the magnitude.

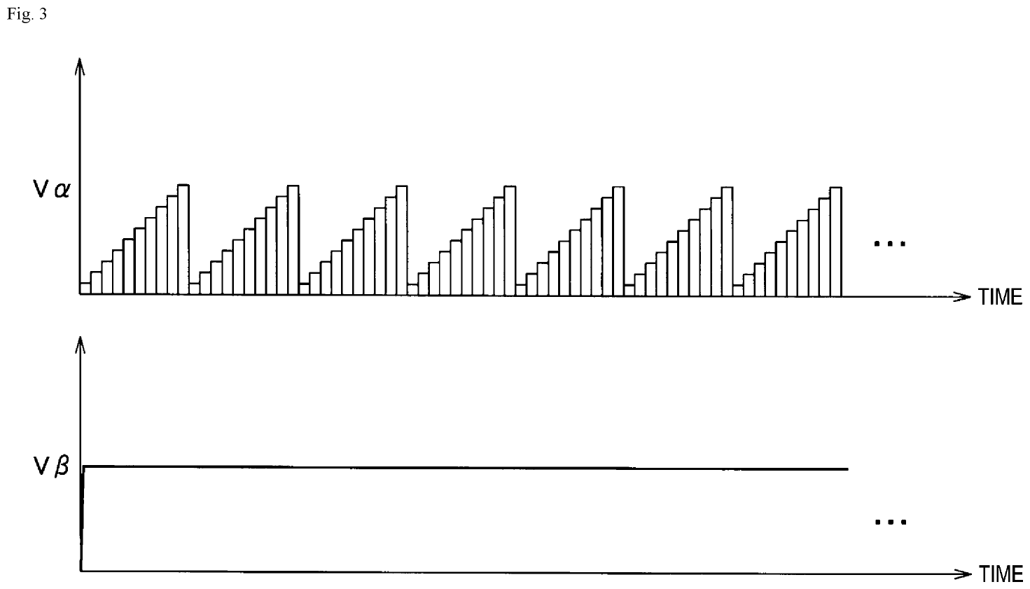

FIG. 3 is a view schematically illustrating another example of the first stimulus signal α and an example of the second stimulus signal β. The examples in FIG. 3 are a voltage signal in which the first stimulus signal α changes in the saw wave and the second stimulus signal β changes on and off.

The first stimulus conversion unit 14 converts the first stimulus signal α into vibration that is one type of stimulus. For example, the first stimulus conversion unit 14 is the DC motor (vibration motor).

The second stimulus conversion unit 15 converts the second stimulus signal β into wind that is the other type of stimulus. For example, the second stimulus conversion unit 15 is a micro fan.

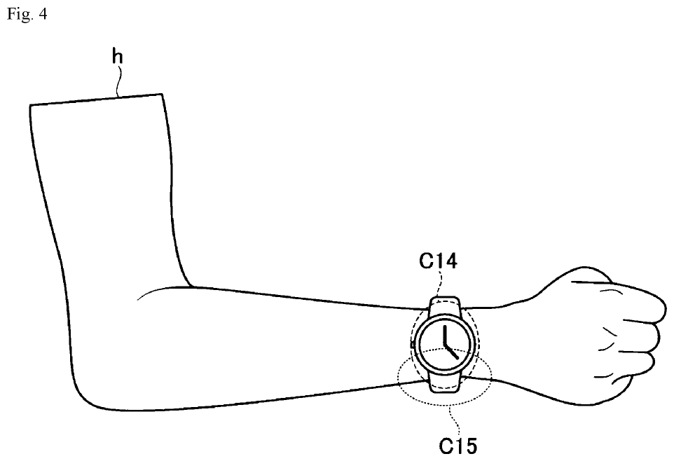

FIG. 4 is a view schematically illustrating a state in which different types of stimuli are generated and presented by the motion sense stimulus presentation system 100. The example in FIG. 4 illustrates the case where the motion sense stimulus presentation system 100 is mounted on a smartphone and held by a user h at a wrist.

In FIG. 4, the first stimulus conversion unit 14 is a disc type vibration motor (not illustrated) disposed on a back cover side of a case of the smartphone. The second stimulus conversion unit 15 is a micro-fan (not illustrated) including air entrances (not illustrated) on the right and left on a 12-hour side of the case of the smartphone.

An oval C14 in a vertical direction indicated by long dashed lines in FIG. 4 schematically illustrates a vibration stimulus presented by the first stimulus conversion unit 14. Furthermore, an oval C15 in a horizontal direction indicated by short dashed lines schematically illustrates a wind stimulus presented by the second stimulus conversion unit 15.

In FIG. 4, the wind stimulus is presented from the wrist toward the elbow while the vibration stimulus is presented at the wrist. Then, the user h feels that the vibration stimulus of the wrist moves toward the elbow by several centimeters.

The wind stimulus is presented from the wrist towards a fingertip while the vibration stimulus is presented at the wrist. Then, the user h feels that the wrist vibration stimulus moves toward a palm of the hand by several centimeters.

As described above, the motion sense stimulus presentation system 100 of the embodiment that presents the motion sense, which is the sense representing the motion, by generating different types of stimuli includes the stimulus signal generation unit 13 that generates the first stimulus signal α and the second stimulus signal β in accordance with the first stimulus parameter and the second stimulus parameter, the first stimulus conversion unit 14 that converts the first stimulus signal α into one type of stimulus, and the second stimulus conversion unit 15 that changes the second stimulus signal β to the other type of stimulus. This enables the motion sense, which is the sense representing the motion, to be presented without the plurality of vibration motors.

### Second Embodiment

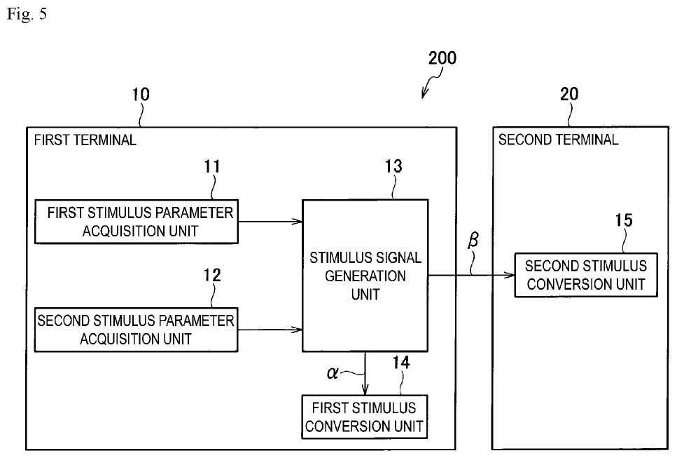

FIG. 5 is a block diagram illustrating a functional configuration example of a motion sense stimulus presentation system according to a second embodiment of the present disclosure. A motion sense stimulus presentation system 200 in FIG. 5 differs from the motion sense stimulus presentation system 100 in that the motion sense stimulus presentation system 200 includes a first terminal 10 and a second terminal 20.

The first terminal 10 includes the first stimulus parameter acquisition unit 11, the second stimulus parameter acquisition unit 12, the stimulus signal generation unit 13, and the first stimulus conversion unit 14. The first stimulus parameter acquisition unit 11 and the second stimulus parameter acquisition unit 12 does not need to be provided similarly to the first embodiment.

The second terminal 20 includes the second stimulus conversion unit 15. In this way, in the motion sense stimulus presentation system 200 of the embodiment, the motion sense stimulus presentation system 100 (FIG. 1) is constituted by two terminals.

The stimulus signal generation unit 13 of the first terminal 10 and the second stimulus conversion unit 15 of the second terminal 20 are connected to each other with the second stimulus signal β. The connection may be wireless or wired.

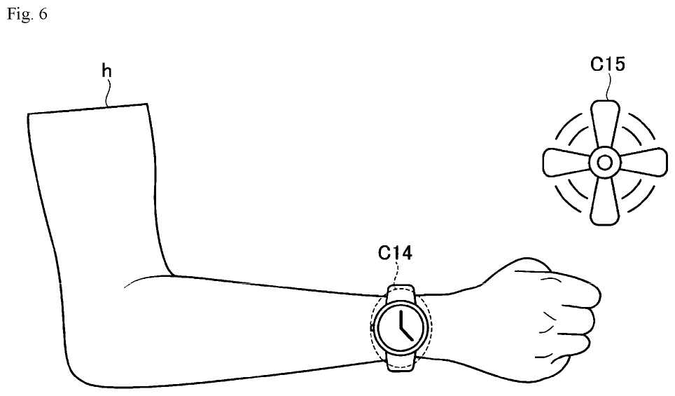

FIG. 6 is a view schematically illustrating a configuration example of the first terminal 10 and the second terminal 20. FIG. 6 illustrates an example in which the first terminal 10 and the second terminal 20 are connected by, for example, a short-range radio (Bluetooth or the like).

As illustrated in FIG. 6, for example, the smartphone of the first terminal 10 provides the vibration stimulus to the wrist portion of the user h. The second terminal 20 provides a wind stimulus C15 towards a portion where the vibration stimulus C14 is presented. The wind stimulus may be provided toward an elbow direction from the fingertip direction of the user h or provided toward the fingertip from the elbow.

According to the embodiment, the wind stimulus greater than that of the first embodiment can be generated, and a degree of freedom in the direction providing the wind stimulus can also be improved. Consequently, the motion sense can be more easily presented.

### Third Embodiment

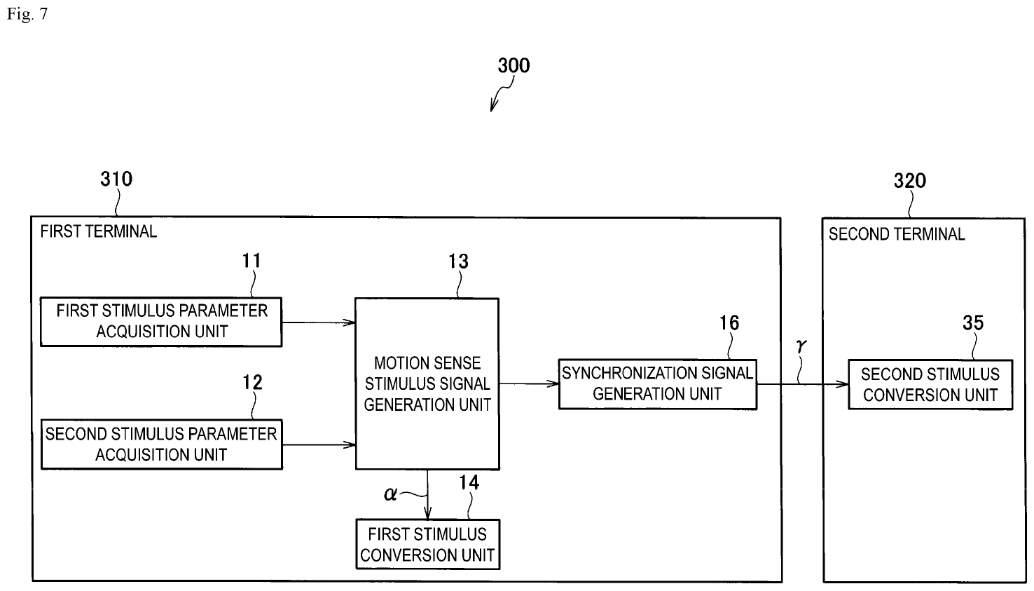

FIG. 7 is a block diagram illustrating a functional configuration example of a motion sense stimulus presentation system according to a third embodiment of the present disclosure. A motion sense stimulus presentation system 300 in FIG. 7 differs from the motion sense stimulus presentation systems 100, 200 in that the signal connecting a first terminal 310 and a second terminal 320 is a synchronization signal γ, and that a second stimulus conversion unit 35 generates the second stimulus signal β to present the second stimulus in accordance with the synchronization signal γ.

The synchronization signal γ represents timing at which the second stimulus presented by the second terminal 320 is generated. For example, the synchronization signal γ is a pulse signal.

The second stimulus conversion unit 35 may generate the second stimulus signal β immediately after the synchronization signal γ is input from the first terminal 310, or generate the second stimulus signal β while the second stimulus signal β is delayed for a predetermined time. This can improve the degree of freedom of the timing at which the second stimulus is presented.

In addition, a plurality of second terminals 320 may be provided, and a plurality of different types of second stimuli may be presented to the synchronization signal γ. Examples of different types of stimuli include light, heat, and sound.

As described above, the first terminal 310 of the motion sense stimulus presentation system 300 of the embodiment includes the synchronization signal generation unit 16 that generates the synchronization signal γ representing timing of generating the first stimulus signal α, and the second terminal 320 includes the second stimulus conversion unit 35 that generates the second stimulus signal β in accordance with the synchronization signal γ. Consequently, the timing of presenting the second stimulus and the option of the type of second stimulus can be increased, and the motion sense can be easily presented.

### Verification Experiment

In order to confirm the effects of the embodiments described above, verification experiment was performed in the configuration of the motion sense stimulus presentation system 200 (FIG. 5).

The experimental conditions were as follows. The first stimulus conversion unit 14 was constituted by a disc type vibration motor (FM34F). In the first stimulus signal α, a pulse width modulation (PWM) signal was used, and the vibration intensity was set to 10% to 100% for each 100 ms. The second stimulus conversion unit 15 was constituted by a small fan. The wind was generated by changing the wrist to elbow or elbow to the wrist direction. The wind intensity was constant and synchronized with the vibration.

When the experiment was performed to two test subjects, the motion sense in which the vibration stimulus was moved by several centimeters with respect to the direction in which the wind hits.

### Motion Sense Stimulus Presentation Method

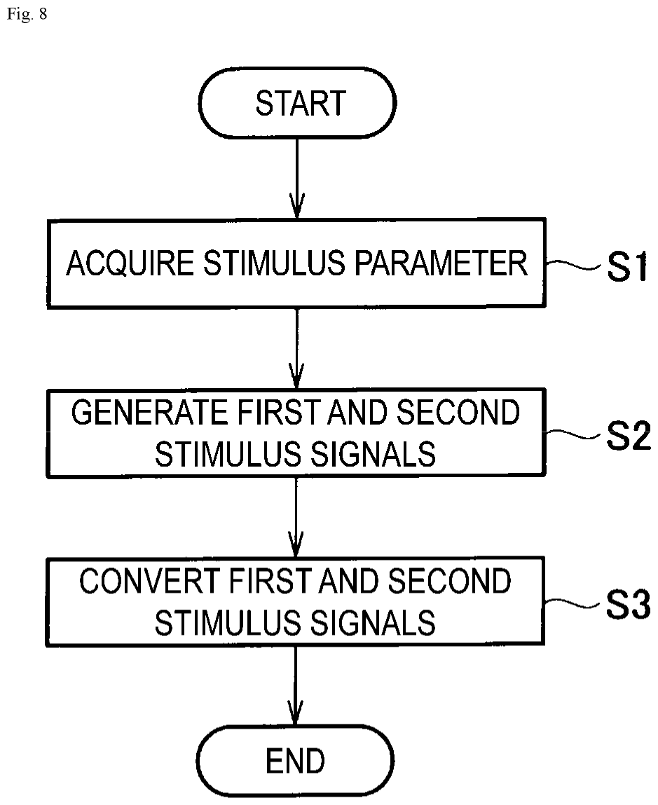

FIG. 8 is an operation flow chart illustrating a processing step of a motion sense stimulus presentation method performed by the motion sense stimulus presentation system.

The first stimulus parameter acquisition unit 11 acquires each piece of information such as the amplitude, the frequency, and the presentation time, which are parameters of the vibration stimulus (step S1). Furthermore, the second stimulus parameter acquisition unit 12 acquires each piece of information such as the intensity, the air orientation, and the presentation time, which are parameters of the wind stimulus (step S1).

Subsequently, the stimulus signal generation unit 13 generates the first stimulus signal α and the second stimulus signal β in accordance with the first stimulus parameter and the second stimulus parameter (step S2).

Subsequently, the first stimulus conversion unit 14 converts the first stimulus signal α into one type of stimulus (step S3). The second stimulus conversion unit 15 converts the second stimulus signal β into the other type of stimulus (step S3). The first stimulus conversion unit 14 and the second stimulus conversion unit 15 may simultaneously convert the stimulus signal into the stimulus.

The motion sense stimulus presentation method of the embodiment enables the motion sense, which is the sense representing the motion, to be presented without the plurality of vibration motors.

As described above, the motion sense stimulus presentation systems 100, 200, and 300 of the embodiments that present the motion sense, which is the sense representing the motion, by generating different types of stimuli include the stimulus signal generation unit 13 that generates the first stimulus signal α and the second stimulus signal β in accordance with the first stimulus parameter and the second stimulus parameter, the first stimulus conversion unit 14 that converts the first stimulus signal α into one type of stimulus, and the second stimulus conversion unit 15 that changes the second stimulus signal β to the other type of stimulus.

For example, the vibration exemplifies the first stimulus and the wind exemplifies the second stimulus, but the present disclosure is not limited to these examples. The vibration of the first stimulus may be changed to inertial force by an inertial force presentation device, movement of the centroid (weight) by a centroid movement device, or the like. Also, the wind of the second stimulus may be changed to sound, light, heat, or the like.

Additionally, the motion sense stimulus presentation system does not need to be constituted by a single terminal (housing). It may be constituted by a plurality of terminals.

It is a matter of course that various embodiments and the like that are not described herein are also included in the present disclosure. Thus, the technical scope of the present disclosure is defined only invention-specific matters according to the claims that are appropriate based on the description above.

### REFERENCE SIGNS LIST

10: First terminal

11: First stimulus parameter acquisition unit

12: Second stimulus parameter acquisition unit

13: Stimulus signal generation unit

14: First stimulus conversion unit

15, 35: Second stimulus conversion unit

16: Synchronization signal generation unit

20: Second terminal

100, 200, 300: Motion sense stimulus presentation system

α: First stimulus signal

β: Second stimulus signal

γ: Synchronization signal

1. A motion sense stimulus presentation system for presenting a motion sense, which is a sense representing a motion, by generating different types of stimuli, the motion sense stimulus presentation system comprising:
a stimulus signal generation unit, including one or more processors, configured to generate a first stimulus signal and a second stimulus signal in accordance with a first stimulus parameter and a second stimulus parameter;
a first stimulus conversion unit, including one or more processors, configured to convert the first stimulus signal into one of the different types of stimuli; and
a second stimulus conversion unit, including one or more processors, configured to change the second stimulus signal to the other of the different types of stimuli.

2. The motion sense stimulus presentation system according to claim 1, wherein
the first stimulus conversion unit is configured to convert the first stimulus signal into vibration, and
the second stimulus conversion unit is configured to convert the second stimulus signal into wind.

3. The motion sense stimulus presentation system according to claim 1, comprising
a first terminal and a second terminal, wherein
the first terminal includes the stimulus signal generation unit and the first stimulus conversion unit, and
the second terminal includes the second stimulus conversion unit.

4. The motion sense stimulus presentation system according to claim 3, wherein
the first terminal includes a synchronization signal generation unit, including one or more processors, configured to generate a synchronization signal representing timing of generating the first stimulus signal, and
the second stimulus conversion unit includes a second stimulus signal generation unit including one or more processors, configured to generate the second stimulus signal in accordance with the synchronization signal.

5. A motion sense stimulus presentation method performed by a motion sense stimulus presentation system, the motion sense stimulus presentation method comprising:
generating, by a stimulus signal generation unit, a first stimulus signal and a second stimulus signal in accordance with a first stimulus parameter and a second stimulus parameter;
converting, by a first stimulus conversion unit, the first stimulus signal into one type of stimulus; and
converting, by a second stimulus conversion unit, the second stimulus signal into the other type of stimulus.

6. The motion sense stimulus presentation method according to claim 5, comprising:
converting the first stimulus signal into vibration, and
converting the second stimulus signal into wind.

7. The motion sense stimulus presentation method according to claim 5, comprising
a first terminal and a second terminal, wherein
the first terminal includes the stimulus signal generation unit and the first stimulus conversion unit, and
the second terminal includes the second stimulus conversion unit.

8. The motion sense stimulus presentation method according to claim 7, comprising:
generating a synchronization signal representing timing of generating the first stimulus signal; and
generating the second stimulus signal in accordance with the synchronization signal.
